(19) United States
(12) Patent Application Publication
(10) Pub. No.: US 2024/0391238 A1
(43) Pub. Date: Nov. 28, 2024

(54) INK JET PRINT HEAD NOZZLE MATRIX LAYOUT

(71) Applicant: FUJIFILM Dimatix, Inc., Lebanon, NH (US)

(72) Inventors: Daniel W. Barnett, Plainfield, NH (US); Christoph Menzel, New London, NH (US); Saurabh Halwawala, Lebanon, NH (US); Kevin von Essen, San Jose, CA (US); Robert Vivanco, Carmichael, CA (US); James Myrick, Rutland, VT (US); Sean Cahill, Lebanon, NH (US)

(21) Appl. No.: 18/672,828

(22) Filed: May 23, 2024

Related U.S. Application Data
(60) Provisional application No. 63/468,423, filed on May 23, 2023.

(51) Int. Cl. B41J 2/145; B41J 2/14; B41J 2/175

(52) U.S. Cl. CPC B41J 2/145; B41J 2/14201; B41J 2/17596

(57) ABSTRACT

An ink jet printing system includes: a print head including multiple fluid ejectors, each fluid ejector including a corresponding nozzle defined in a bottom surface of the print head, each nozzle configured to eject a liquid onto a substrate. The nozzles can be arranged in an array including four or more parallel rows, the rows extending along a direction that is perpendicular to a process direction of the ink jet printing system. The process direction is the direction of relative motion between the print head and the substrate during operation of the print head. A spacing between adjacent nozzles in each row can be such that a nozzle density in each row is less than 75 nozzles per inch. A spacing between adjacent rows in the process direction can be less than the spacing between adjacent nozzles in each row.

### CLAIM OF PRIORITY

This application claims priority under 35 USC § 119(e) to U.S. Patent Application Ser. No. 63/468,423 filed on May 23, 2023, the entire contents of which are hereby incorporated by reference.

### BACKGROUND

Ink jet printing can be performed using an ink jet print head that includes multiple nozzles. Ink is introduced into the ink jet print head and, when activated, the nozzles eject droplets of ink to form an image on a substrate.

### SUMMARY

We describe here a nozzle matrix configuration to be used in ink jet printing that can mitigate various printing defects that occur when printing. Examples of defects include wood grain defects, yaw-induced defects, and ink spread phenomena. The design of the nozzle matrix configuration is a balance among nozzle arrangements that provide targeted performance for mitigation of each type of defect. In addition, the nozzle matrix configuration can be designed to reduce or minimize pressure drops in the feed channels supplying the nozzles. Jetting sequences for these nozzle matrix configurations can be designed to mitigate nonuniform ink spread, e.g., by avoiding successive jetting of adjacent nozzles.

Nozzle matrix configurations that can mitigate wood grain defects have relatively wide spacing between nozzles within rows of nozzles that are orthogonal to the process direction (e.g., compared to the spacing between rows), which can mitigate wood grain defects and allow for high quality printing at relatively high speeds, e.g., 1-2 meters per second. Additionally, the rows of nozzles in the nozzle matrix are offset from one another, thus defining a serpentine path of nozzles from row to row, which can mitigate edge effects in woodgrain defects by improving airflow. Nozzle matrix configurations that mitigate yaw-related defects have offsets between nozzles along the process direction that are within a prescribed range; the range of nozzle offsets also impacts the arrangement of the feed channels. The described nozzle matrix configuration is provided in four or more closely spaced rows of nozzles.

In general, the subject matter described in this specification can be embodied in an ink jet printing system that includes: a print head including multiple fluid ejectors, each fluid ejector including a corresponding nozzle defined in a bottom surface of the print head, each nozzle configured to eject a liquid onto a substrate. The nozzles can be arranged in an array, e.g., including four or more, e.g., more than four, parallel rows, the rows extending along a direction that is perpendicular to a process direction of the ink jet printing system. The process direction is the direction of relative motion between the print head and the substrate during operation of the print head. A spacing between adjacent nozzles in each row can be such that a nozzle density in each row is less than 75 nozzles per inch. A spacing between adjacent rows in the process direction can be less than the spacing between adjacent nozzles in each row.

These and other implementations can each optionally include one or more of the following features.

In some implementations, the spacing between adjacent nozzles in each row is such that the nozzle density in each row is 50 nozzles per inch.

In some implementations, the nozzles are arranged in at least eight rows.

In some implementations, the nozzles are arranged in at least twelve rows.

In some implementations, the spacing between adjacent rows in the process direction is less than 500 μm.

In some implementations, the spacing between adjacent nozzles in each row is such that the nozzle density in each row is 50 nozzles per inch. The spacing between adjacent rows can be between 400 μm and 450 μm. The nozzles can be arranged in exactly twelve rows.

In some implementations, a first nozzle in a given row is offset along the direction of the row relative to a first nozzle in an adjacent row.

In some implementations, a first nozzle of each of the rows defines a serpentine path extending along the process direction.

In some implementations, including multiple feed channels defined in the print head, each feed channel fluidically connected to a corresponding subset of the fluid ejectors.

In some implementations, the fluid ejectors are arranged in an array corresponding to the array of nozzles, and all of the feed channels are disposed on a common side of the array of fluid ejectors.

In some implementations, fluid connections between each feed channel and the corresponding subset of the fluid ejectors extend between rows of fluid ejectors in the array of fluid ejectors.

In some implementations, the system includes a print bar including multiple print heads. The rows of nozzles on each print head can be aligned with the rows of nozzles on each other print head.

In some implementations, the print heads are rectangular print heads.

In some implementations, each fluid ejector includes: a pumping chamber fluidically connected to the nozzle of the fluid ejector by a descender; and an actuator configured to apply an actuation force to fluid in the pumping chamber to cause ejection of fluid from the nozzle of the fluid ejector.

In some implementations, each actuator includes: a piezoelectric element; and a membrane defining a wall of the pumping chamber opposite the descender, the membrane disposed between the pumping chamber and the piezoelectric element.

In some implementations, the descender is centered relative to the pumping chamber.

In some implementations, each fluid ejector includes a recirculation channel fluidically connected to the descender such that, during operation, fluid not ejected from the nozzle of the fluid ejector flows from the nozzle through the recirculation channel and to a reservoir.

In some implementations, the spacing between adjacent nozzles in each row is uniform for centrally located adjacent nozzles and non-uniform for adjacent nozzles located at edges of each row.

In some implementations, the spacing between adjacent rows is uniform throughout the array.

In some implementations, an offset between first nozzles in any two given rows is an integer multiple of an offset between first nozzles in adjacent rows.

In an aspect, an ink jet printing system includes a print head including multiple fluid ejectors, each fluid ejector including a corresponding nozzle defined in a bottom surface of the print head, each nozzle configured to eject a liquid onto a substrate, wherein the nozzles are arranged in an array including four or more parallel rows, the rows extending along a direction that is perpendicular to a process direction of the ink jet printing system, wherein the process direction is the direction of relative motion between the print head and the substrate during operation of the print head, wherein a spacing between adjacent nozzles in each row is such that a nozzle density in each row is less than 75 nozzles per inch, and wherein a spacing between adjacent rows in the process direction is less than the spacing between adjacent nozzles in each row.

Embodiments can include one or any combination of two or more of the following features.

In some implementations, the spacing between adjacent nozzles in each row is such that the nozzle density in each row is 50 nozzles per inch.

In some implementations, the nozzles are arranged in at least eight rows.

In some implementations, the nozzles are arranged in at least twelve rows.

In some implementations, the spacing between adjacent rows in the process direction is less than 500 μm.

In some implementations, the spacing between adjacent nozzles in each row is such that the nozzle density in each row is 50 nozzles per inch, wherein the spacing between adjacent rows is between 400 μm and 450 μm, and wherein the nozzles are arranged in exactly twelve rows.

In some implementations, a first nozzle in a given row is offset along the direction of the row relative to a first nozzle in an adjacent row.

In some implementations, a first nozzle of each of the rows defines a serpentine path extending along the process direction.

In some implementations, the system includes multiple feed channels defined in the print head, each feed channel fluidically connected to a corresponding subset of the fluid ejectors.

In some implementations, the fluid ejectors are arranged in an array corresponding to the array of nozzles, and wherein all of the multiple feed channels are disposed on a common side of the array of fluid ejectors.

In some implementations, fluid connections between each feed channel and the corresponding subset of the fluid ejectors extend between rows of fluid ejectors in the array of fluid ejectors.

In some implementations, the system includes a print bar including multiple print heads, wherein the rows of nozzles on each print head are aligned with the rows of nozzles on each other print head.

In some implementations, the print heads are rectangular print heads.

In some implementations, each fluid ejector includes a pumping chamber fluidically connected to the nozzle of the fluid ejector by a descender; and an actuator configured to apply an actuation force to fluid in the pumping chamber to cause ejection of fluid from the nozzle of the fluid ejector.

In some implementations, each actuator includes a piezoelectric element; and a membrane defining a wall of the pumping chamber opposite the descender, the membrane disposed between the pumping chamber and the piezoelectric element.

In some implementations, the descender is centered relative to the pumping chamber.

In some implementations, each fluid ejector includes a recirculation channel fluidically connected to the descender such that, during operation, fluid not ejected from the nozzle of the fluid ejector flows from the nozzle through the recirculation channel and to a reservoir.

In some implementations, the spacing between adjacent nozzles in each row is uniform for centrally located adjacent nozzles and non-uniform for adjacent nozzles located at edges of each row.

In some implementations, the spacing between adjacent rows is uniform throughout the array.

In some implementations, an offset between first nozzles in any two given rows is an integer multiple of the spacing between nozzles in a given row divided by a total number of rows.

In some implementations, the offset between first nozzles in adjacent rows does not exceed three times a spacing of nozzles within a row divided by the total number of rows.

In some implementations, the array of nozzles includes columns of nozzles, the columns extending along a direction that is parallel to the process direction of the ink jet printing system, and wherein nozzles in adjacent rows are separated by at least one intervening column.

In some implementations, nozzles in adjacent rows are separated by four or fewer intervening columns.

In some implementations, the array includes more than four parallel rows.

In an aspect, a method of inkjet printing using any one or more of the embodiments of the foregoing system includes ejecting ink from the nozzles in the array, wherein the array includes columns of nozzles, the columns extending along a direction that is parallel to the process direction of the ink jet printing system, the ejecting including: ejecting ink from a first nozzle in the array, the first nozzle disposed in a first column of the array; and after ejecting ink from the first nozzle, ejecting ink from a second nozzle in the array, the second nozzle disposed in second column of the array that is not adjacent to the first column of the first nozzle.

Embodiments can include one or any combination of two or more of the following features.

In some implementations, the first and second columns are separated by between one and four other columns.

In some implementations, the ejecting includes ejecting ink sequentially from multiple nozzles in the array, in which sequentially operated nozzles are disposed in non-adjacent columns in the array.

In some implementations, nozzles disposed in adjacent columns are separated by a number of rows that is no more than two-thirds of the total number of rows in the array.

In some implementations, the array includes multiple sub-groups of nozzles, the sub-groups having a common arrangement of nozzles, and wherein the ejecting includes: ejecting ink from a first nozzle of each sub-group of nozzles, each first nozzle disposed in a first column of the respective sub-group; and after ejecting ink from the first nozzle of each sub-group, ejecting ink from a second nozzle of each sub-group, each second nozzle disposed in second column of the respective sub-group that is not adjacent to the first column of the first nozzle of the sub-group.

In some implementations, each sub-group of nozzles is supplied by a corresponding feed channel, and wherein consecutive nozzles of a given sub-group along the corresponding feed channel are separated by a number of rows that is no more than two-thirds of the total number of rows in the sub-group of nozzles.

Other features and advantages are apparent from the following description and from the claims.

### BRIEF DESCRIPTION OF DRAWINGS

FIG. 1 is an example wood grain defect.

FIG. 2A is a diagram of an ink jet printing system.

FIG. 2B is a schematic of a nozzle matrix.

FIG. 3A is an example of a nozzle matrix.

FIG. 3B is an illustration of air flow through a nozzle matrix.

FIG. 4A is an illustration of a print head.

FIG. 4B is an illustration of a print head assembly.

FIG. 5 is a side view of a fluid ejector.

FIG. 6 is a cross-sectional perspective view of a portion of a print head.

FIG. 7 is a cross sectional view of a portion of a print head.

FIGS. 8A and 8B are bottom and top views, respectively, of a nozzle matrix.

### DETAILED DESCRIPTION

We describe here a nozzle matrix configuration to be used in ink jet printing that can mitigate various printing defects that occur when printing. A nozzle matrix having relatively wide spacing between nozzles within rows of nozzles that are orthogonal to the process direction (e.g., compared to the spacing between rows) can mitigate wood grain and edge defects and allow for high quality printing at relatively high speeds, e.g., 1-2 meters per second. Additionally, the rows of nozzles in the nozzle matrix are offset from one another, thus defining a serpentine path of nozzles from row to row, which can mitigate edge effects in woodgrain defects by improving airflow. The described nozzle matrix configuration is provided in four or more, e.g., more than four, closely spaced rows of nozzles.

High quality printing generally is achieved by providing a high density of nozzles in a print head, e.g., by reducing the spacing both within and between rows. A high density of nozzles also generally allows for cost-effective production, e.g., in that many nozzles are formed on a relatively small substrate (e.g., a silicon substrate). However, the inventors have determined that the likelihood of printing defects such as wood grain defects is sensitive to the spacing between nozzles, and specifically, is more sensitive to the spacing between nozzles within each row than to the spacing between rows. Accordingly, we describe here a nozzle matrix layout in which the spacing between rows is smaller relative to the spacing between nozzles within rows. This arrangement enables rapid and high-resolution printing while reducing the occurrence of wood grain defects even at high printing speeds. The resulting capabilities of the described nozzle matrix are counterintuitive results in an industry that generally attempts to fit as many nozzles onto a print head as possible to improve dpi and reduce the manufacturing costs.

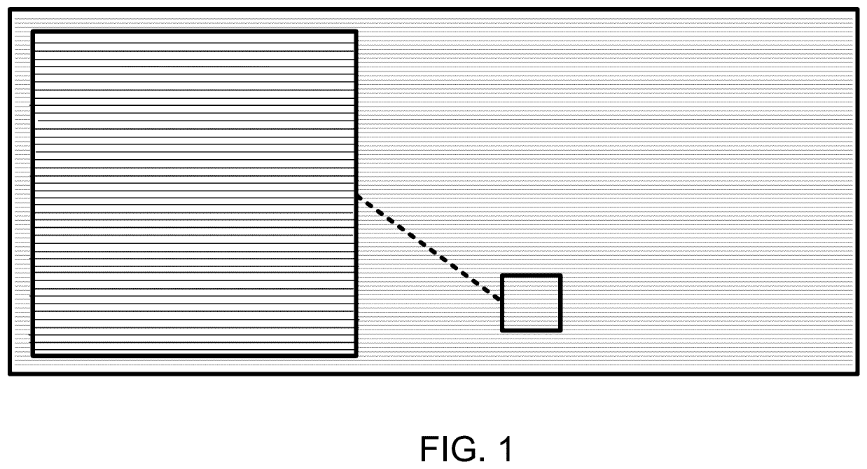

Examples of wood grain defects are illustrated in FIG. 1. Gas flow patterns between the print head and the substrate can induce wood grain defects in images printed on the substrate. Without being bound by theory, wood grain defects are believed to be caused by unsteady laminar gas flows that develop in the gap between the print head and the substrate, e.g., due to interactions between the droplets of ink and the gas flow or due to interactions between droplets. For instance, unsteady gas flow patterns can cause small, concentrated drop placement errors, e.g., errors typically ranging from about 10-300 microns, in which ink drops group together in certain areas of the printed image to form a pattern that looks like a wood grain, as illustrated in FIG. 1. The approaches described here provide a nozzle matrix layout that reduces the occurrence of wood grain defects, e.g., when printing at high printing speeds, by decreasing the nozzle density in the cross-process direction.

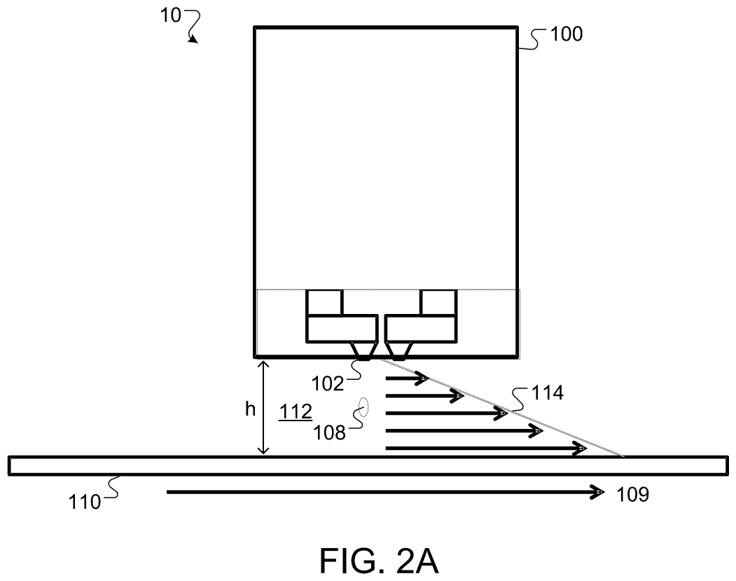

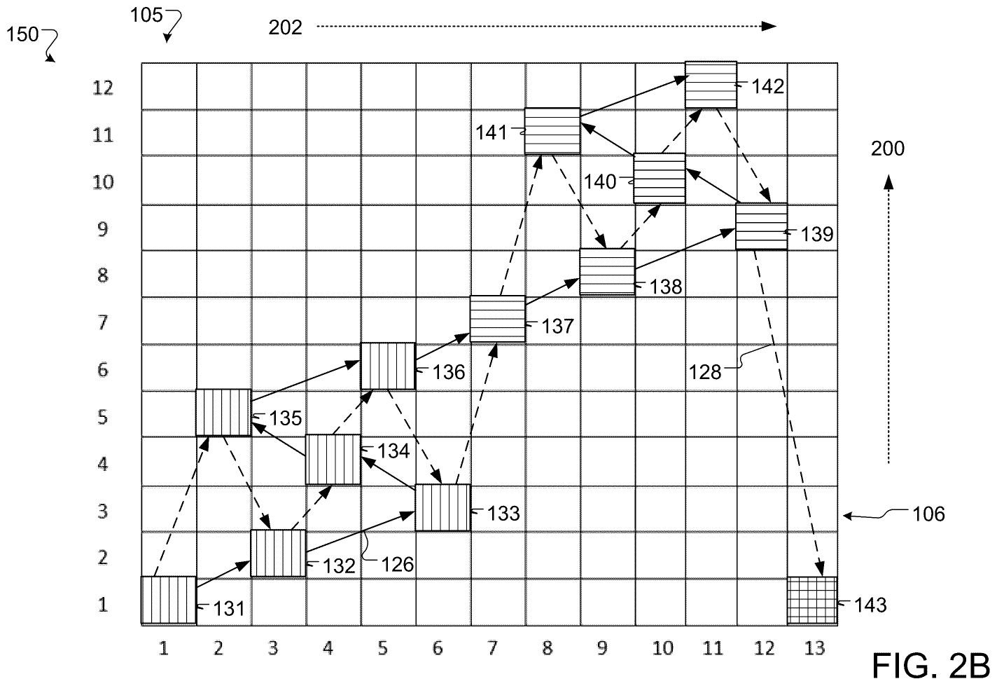

FIG. 2A shows an example of an ink jet printing system 10 that includes an ink jet print head 100 capable of printing an image onto a substrate 110. The print head 100 includes multiple nozzles 102 arranged in a matrix on the bottom surface of the print head 100. For instance, the nozzles 102 can be arranged in multiple rows. Ink drops 108 are jetted from one or more of the nozzles 102, through a gap 112 between the print head 100 and the substrate 110, and onto the substrate 110 to form a printed image on the substrate 110. In some cases, the substrate 110 moves relative to the print head 100 during the printing process, e.g., as indicated by the arrow 109, while the print head 100 remains stationary. In some cases, the substrate 110 remains stationary and the print head 100 moves relative to the substrate 110. In some cases, both the substrate 110 and the print head 100 move.

The resolution of the ink jet printing system 10 is specified in values of dots per inch (dpi). The resolution can be affected by factors such as one or more of the jetting frequency, velocity of substrate relative to the print head and the number of nozzles per unit of distance in the process or cross-process direction, the number of nozzles per unit area of the print head, or other factors. The process direction is the direction of relative motion between the substrate 110 or the print head 100 during printing. The cross-process direction is orthogonal to the process direction. The density of nozzles along the process- and cross-process direction is specified in values of nozzles per inch (npi), e.g., number of nozzles per inch in the respective direction.

FIG. 2B is a schematic of a nozzle matrix 150. The nozzle matrix 150 includes columns 105 of nozzles, e.g., jets, extending along the process direction 200 and rows 106 extending transverse to the process direction 200 (e.g., along the cross-process direction 202). Each combination of row 106 and column 105 corresponds to a pixel. Nozzles can be located at any of the pixels, e.g., nozzle 131 is disposed in the pixel defined by row 1 and column 1. In this example, the nozzle matrix 150 corresponds to a matrix having 12 rows. For this 12 row printhead, there are about 500 million, e.g., 12!, possible combinations of nozzle arrangements, of which certain arrangements are advantageous in terms of achieving high performance printing objectives. For example, the nozzles can be arranged to reduce occurrence of wood grain defects, yaw-related errors, nonuniform ink spread effects, or a combination thereof.

Yaw-related errors can result from slight rotation/misalignment along an axis perpendicular to both the process direction 200 and cross-process direction 202 and/or from manufacturing and system tolerances causing the process direction 200 and rows 106 to not be perfectly perpendicular. Droplet spread effects arise when a second droplet is deposited close to a first droplet before the first droplet has fully spread, such that the adjacent droplets merge and surface tension changes cause both droplets to stop spreading, which can limit total drop spread and reduce overall substrate coverage. Surface tension effects resulting from ink interacting with the substrate cause the line or drop to spread as long as there is liquid ink in the body of the line or drop and provided the advancing contact angle is great enough to pull the advancing edge forward. This spread results in widening of the area covered by the ink from the deposited line or drop, and thus the deposited ink covers more of the substrate without image defects. When a first line of ink merges with a second line of ink adjacent to the first line of ink, the edges of both lines of ink slow their respective outward spread, which prematurely stops the spreading of the ink and can result in white streaks or light coverage areas. Accordingly, designing the nozzle matrix to promote uniform times, uniform distances, or both for ink spread can result in more uniform printed images.

When designing optimal nozzle arrangements to mitigate nonuniform ink spread combined with the effects of other issues, each of these printing issues can sometimes be in tension with one another. Thus, nozzle matrix patterns can be designed to balance reduction of yaw-related errors, ink spread phenomena, and wood grain defects, e.g., by balancing a trade-off among multiple design variables. Moreover, design of nozzle matrix patterns can take into account the arrangements of feed channels that would be used to supply those nozzles.

Nozzle matrix patterns that reduce or minimize yaw error can be designed using statistical analysis to broaden the standard deviation of error based on small changes to the nozzle pattern. Generally, nozzle patterns that reduce or minimize yaw-related error have small separations along the process direction between adjacent nozzles; large process direction spacings between nozzles increases the average error. A nozzle matrix pattern designed to minimize yaw error, without consideration of ink spread or wood grain defects, would have small and identical process direction distances between adjacent nozzles for all nozzles in the nozzle matrix. However, this general design rule is implemented in conjunction with design rules to reduce nonuniform ink spread and wood grain defects, as well as to comply with design criteria for the arrangement of feed channels.

An example design rule can be a restriction in the offset distance in the cross-process direction between nozzles in adjacent rows. For instance, implementing a rule specifying a lateral separation between consecutively printing nozzles (e.g., nozzles in adjacent rows) can help reduce nonuniform ink spreading.

Another example design rule can be a restriction in the offset distance in the process direction between nozzles in adjacent columns (e.g., laterally adjacent nozzles). For instance, a minimum offset in the process direction can help reduce yaw sensitivity.

Still another example design rule can be a restriction in the offset distance in the process direction between consecutive nozzles along the fluid supply pathway, e.g., consecutive nozzles along a feed channel. For instance, a minimum offset in the process direction for nozzles along a same feed channel can prevent narrowing of the feed channel, thus helping to avoid detrimental pressure reductions that would result from such a configuration.

The shaded pixels in FIG. 2B indicate pixels that are occupied by nozzles in an example nozzle matrix pattern. This nozzle arrangement includes a repeating pattern that constitutes two sub-groups, each with six nozzles. The first sub-group of nozzles, indicated by vertical lines filling the respective pixels, has its origin at pixel (1,1) and includes nozzle 131 at (1,1), nozzle 132 at (2,3), nozzle 133 at (3,6), nozzle 134 at (4,4), nozzle 135 at (5,2), and nozzle 136 at (6,5). The numbering of reference numerals for the nozzles corresponds to the row of each nozzle and is not indicative that consecutively numbered nozzles are adjacent. For instance, in the FIG. 2B example, nozzles 131 and 135 correspond to adjacent jets (e.g., nozzles 131 and 135 are located in consecutive columns). The second sub-group of nozzles 137-142, indicated by horizontal lines filling the respective pixels, has an arrangement that corresponds to the arrangement of the first sub-group, and has an origin at pixel (7,7). A third sub-group of nozzles begins at pixel (1,13), e.g., displaced by +12 columns from the first nozzle 131 of the first sub-group, as indicated by a hashed fill of the pixel. The third sub-group of nozzles also has the same arrangement of nozzles as the first and second sub-groups. Although the illustrated nozzle matrix pattern has a repeated geometric configuration of two groups, other repeat patterns are possible, e.g., repeated geometric configurations of groups of 3, 4, or 6. In some examples, the nozzles can be arranged in a unique grouping of 12.

The print order of the nozzles is indicated by solid arrows 126, e.g., the order in which nozzles eject fluid in time (scanning along the process direction 200). The print order (solid lines) goes in sequential order of the row number, e.g., from row 1 to row 2 and so on. The fluid path for supplying fluid to each of the nozzles within a sub-group of nozzles, e.g., via a feed channel, is indicated by dashed lines 128. The fluid supply path (dashed lines) goes in sequential order of the column number, e.g., from column 1 to column 2 and so on.

One example design rule that aims to avoid sharp jogs in the feed channel specifies a restriction in the offset distance in the process direction between consecutive nozzles along a feed channel, e.g., a maximum offset in the process (y) direction. Offsets larger than a threshold amount can necessitate a narrowing of the ink feed channel, which would lead to a higher pressure drop that would impact fluid flow to the nozzle. For instance, the impedance of the channel is a function of width, and any offset (sometimes also referred to as a “jog”) that is greater than four pixels can result in channel narrowing to a degree that may risk pressure-drop induced print errors, e.g., impacting meniscus range of downstream nozzles, restrict the supply of ink to downstream nozzles (starvation), or both. This maximum offset design rule can be particularly relevant when the jet-to-jet spacing in a row is less than or equal to the column spacing, which corresponds to compression of the feed channels and feed channel walls.

Generally, the design rule that relates to feed channel configuration considerations specifies the maximum offset as a function of the number of rows of nozzles in each sub-group of nozzles. For instance, as a general rule, the maximum offset along the process direction between consecutive nozzles along a feed channel can be two-thirds of the number of rows of nozzles in the sub-group. In the specific example of FIG. 2B, then, this maximum offset is 4 rows.

Another example design rule that aims to reduce yaw sensitivity specifies a restriction in the offset distance in the process direction between nozzles in adjacent columns (e.g., laterally adjacent nozzles), e.g., a maximum offset in the process (y) direction. Offsets larger than a threshold amount render the nozzle pattern vulnerable to yaw related errors. Generally, the design rule that relates to yaw sensitivity considerations specifies the maximum offset as a function of the number of rows of nozzles in the entire array of nozzles. For instance, as a general rule, the maximum offset along the process direction between nozzles in adjacent columns can be two-thirds of the total number of rows of nozzles in the entire array of nozzles. In the specific example of FIG. 2B, then, this maximum offset is 8 rows.

In the example of FIG. 2B, which represents one instance of a recurring pattern that repeats every twelve nozzles, each row 106 and each column 105 contains exactly one nozzle in the 12×12 array. For instance, a printhead may have one nozzle per pixel in the cross-process direction. In some examples, multiple droplets from different nozzles can be printed into the same pixel (e.g., a droplet is printed onto an already-printed droplet), e.g., for jetting of multiple colors or multiple types of fluid.

Another example design rule that reduces nonuniform ink spreading specifies a restriction in the offset distance in the cross-process direction between nozzles in adjacent rows, e.g., a maximum offset in the cross-process (x) direction. For instance, the jetting sequence can impact the occurrence and/or nonuniformity of ink spread. In an example, if the jetting pattern provides uniform time or distance for ink spread of a droplet before an immediately adjacent droplet is printed, the ink spread can be controlled and consistent, thus producing a printed image with uniform ink coverage. On the other hand, if droplets from neighboring columns have a spacing in the process direction 200 that is too small, the reduction in line spread can result in uneven coverage. For instance, the design rule can specify that the cross-process direction offset between nozzles in adjacent rows is at least 2 pixels, e.g., specifying a minimum separation.

In the example of FIG. 2B, with this printing sequence, the print order of the nozzles in the first sub-group by column number is 1, 3, 6, 4, 2, 5. That is, consecutively operated nozzles are not disposed in adjacent columns. This arrangement allows for time between adjacent pixels, which reduces occurrence of nonuniform ink spreading errors. Although not depicted, another example of a jetting sequence that reduces or eliminates nonuniform ink spreading is to print nozzles in odd-numbered columns of each sub-group first, followed by the nozzles in even-numbered columns, e.g., by column number 1, 3, 5, 2, 4, 6.

In bidirectional scan printing and single pass printing when a stitched or bricked printhead is rotated 180, the jetting sequence is considered from the perspective of both the first row (row 1 in FIG. 2B) and the last row (row 12), because the direction of the head relative to the substrate is reversed on each successive print pass. For instance, the continuity between lines in the pattern of FIG. 2B risks nonuniform spreading of ink ejected by pixels 3 and 4 toward one another, before droplet 2 has landed between pixels 1 and 3, and before droplet 5 has landed between pixels 4 and 6. This may lead to gaps at the 2/3 pixel interface during the forward pass and at the 4/5 pixel interface during the backward pass. However, as discussed above, design considerations account for trade-offs between, e.g., the risk of such nonuniform ink spread and the mitigation of yaw effects that is afforded by this arrangement.

These various design criteria are balanced during design of a nozzle array. For instance, as illustrated in FIG. 2B, nozzles in a single sub-group, supplied by the same feed channel, are separated by no more than 4 rows in the process direction, to comply with feed channel configuration criteria. Between subgroups, the process direction spacing can be up to 8 rows. Moreover, the lateral spacing between consecutively operated nozzles in the print order is at least one and no more than four columns.

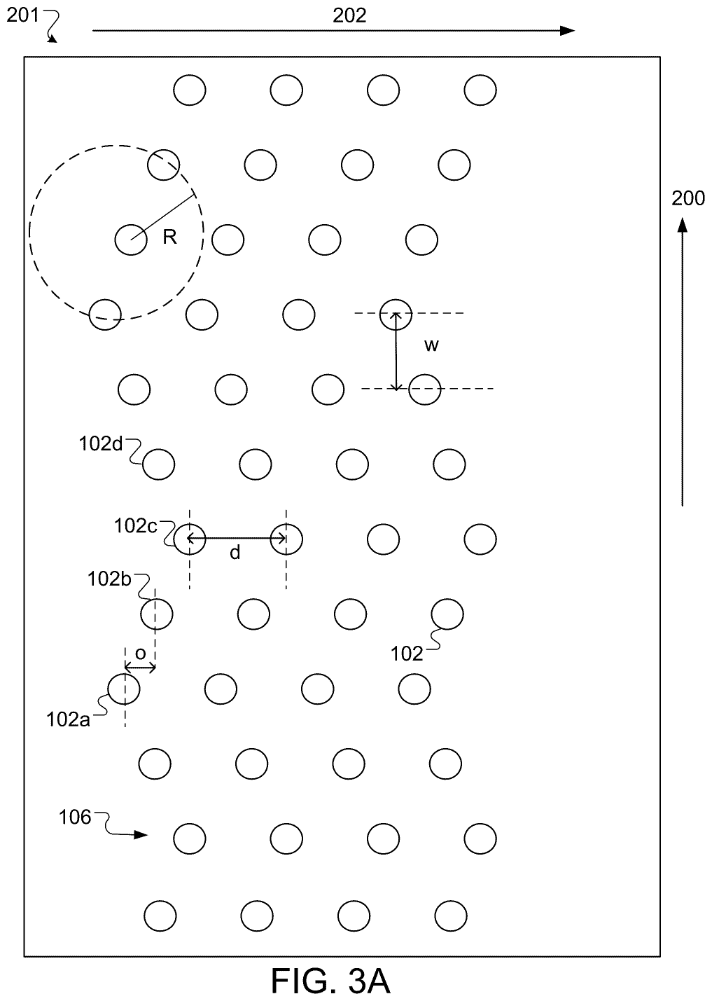

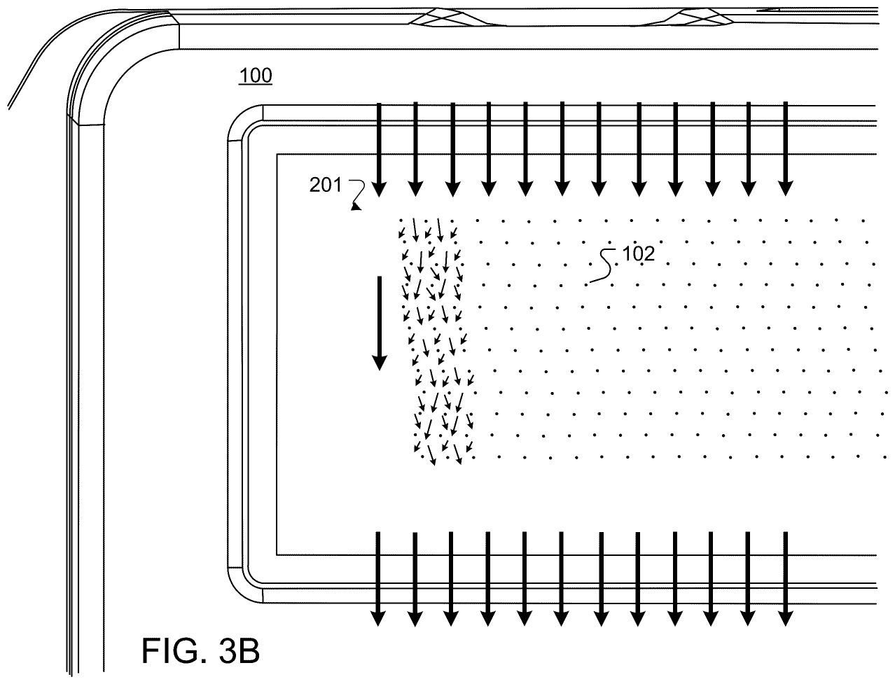

FIG. 2B is referred to as a schematic because a printhead need not be arranged exactly like a rectangular grid like nozzle matrix 150. Rather FIG. 2B represents a pixel grid on a substrate, where each pixel is associated with a nozzle. For example. FIG. 3A depicts an arrangement with similar design principles as FIG. 2B, but with a different physical layout.

FIG. 3A is an example of a nozzle matrix 201. The nozzle matrix 201 can be located on the bottom of the print head 100, and each nozzle 102 can be an aperture (e.g., a conical aperture, a straight aperture, or an aperture of another shape) through the bottom of the print head 100. The nozzle matrix 201 is composed of multiple, parallel rows of nozzles 102. Each row 106 of nozzles 102 is substantially orthogonal to the process direction 200 and substantially parallel to a cross-process direction 202. The process direction 200 is parallel to the direction of the arrow 109 (FIG. 2A) and the cross-process direction 202 is perpendicular to the direction of the arrow 109 and also perpendicular to the plane of the page in FIG. 2A. In some implementations, each row 106 of nozzles 102 has nonzero angle relative to both the process and the cross-process direction.

The spacing between nozzles with a particular row is marked as d, and is the center-to-center of two adjacent nozzles in a row. The spacing between adjacent rows is marked as w, and is the distance along the process direction 200 between the center of a first nozzle in a first row and a second nozzle in a second, adjacent row.

The spacing d between adjacent nozzles in a given row in the cross-process direction 202 has a strong impact on print quality, e.g., wood grain defects (discussed in more detail below). An increase in the spacing d compared to standard nozzle spacing can reduce the occurrence of wood grain defects and can enable printing without such defects, e.g., particularly when printing at high speeds or when printing with a large separation between print head and substrate (referred to as a high stand-off). For instance, and as discussed more below, greater separation between nozzles in each row can lead to less droplet-droplet interaction, which can improve print quality, e.g., especially when printing at high speeds or at high stand-off. For instance, the nozzles are arranged in the cross-process direction such that the nozzle density is less than 100 nozzles per inch (npi), e.g., 80 npi, 75 npi, 60 npi, 50 npi, 40 npi, or 25 npi. In a specific example, the nozzle density in the cross-process direction is 50 npi, which corresponds to a nozzle-to-nozzle spacing d of 508 μm.

Increasing the spacing d between nozzles in a row relative to conventional nozzle arrangements, without further adjustments to the nozzle matrix pattern, would reduce the total number of nozzles on the print head, which could adversely affect print quality (e.g., print resolution). Thus, to provide sufficient nozzles to provide a target print resolution within a given print head surface area, the spacing w between adjacent rows is reduced relative to conventional nozzle arrangements, and a larger number of rows is provided than in conventional nozzle arrangements. In general, the spacing w between adjacent rows is less than the spacing d between adjacent nozzles. For instance, the spacing w between adjacent rows along the process direction is less than 500 μm, e.g., between 300 μm and 500 μm, between 400 μm and 500 μm, or between 400 μm and 450 μm. Additionally, four or more, e.g., more than four, rows of nozzles are provided on the print head, e.g., 8 rows, 10 rows, 12 rows, or 16 rows.

In a specific example, some print heads include 1536 nozzles and obtain a 600 dpi print resolution. In the print heads described here, the nozzle spacing within each row is 50 nozzles per inch, and 12 rows of nozzles are used, spaced at 423 μm between rows, to achieve the 1536 nozzles for 600 dpi print resolution while enabling mitigation of print defects when printing at high speed.

Without being bound by theory, it is believed that the increased spacing d between nozzles in each row, in the cross-process direction, mitigates printing defects such as wood grain defects by alleviating air flow patterns that would occur with a higher per-row nozzle density. For instance, as rows of nozzles are added in the process direction without changing the nozzle density in the cross-process direction, it has been demonstrated that differential pressure in the central region of the nozzle matrix gives rise to droplet interactions that lead to wood grain defects. By spreading out the nozzles in each row, e.g., in the cross-process direction, the air flow pattern is disrupted in a way that mitigates droplet interactions, thus reducing wood grain defects especially when printing at high speeds.

In some implementations, the spacing d in each row 106 is uniform, e.g., a distance between the first pair of adjacent nozzles and a second pair of adjacent nozzles is the same in a particular row and optionally the spacing d in each row 106 is the same. In other implementations, the spacing d in each row 106 is nonuniform, e.g., a distance between the first pair of adjacent nozzles and a second pair of adjacent nozzles is different in a particular row. For example, the spacing d between nozzles in a row can be non-uniform at the edges of rows, which can facilitate stitching multiple print heads together into a print head assembly (discussed below), while uniform for centrally located nozzles. By uniform, we mean substantially uniform, e.g., the spacing between each row being the same within up to 5%.

In some implementations, the spacing w between each row 106 is uniform, e.g., a distance between each pair of adjacent rows is the same. In other implementations, the spacing w between rows 106 is nonuniform, e.g., a distance between one or more pairs of adjacent rows is different.

A first nozzle in one row, e.g., first nozzle 102a, is offset along the cross-process direction 202 by an offset amount o from the first nozzle of an adjacent row, e.g., first nozzle 102b. For instance, the first nozzles of each row define a serpentine path along the process direction 200. By “serpentine,” we mean that the offset between first nozzles in adjacent rows varies between a positive offset and a negative offset. For example, as depicted in FIG. 3A, the offset o between nozzles 102a and 102b is +o, and the offset between o between nozzles 102b and 102c is +o, making the offset between nozzles 102a and 102c +2o. The offset o between nozzles 102c and 102d is −o, making the offset between nozzles 102b and 102d zero. In other words, the absolute value of the offset between first nozzles in adjacent rows can be the same, but the direction of the offset can be positive or negative. In some implementations, the offset between any two first nozzles in different rows can be an integer multiple of the offset between adjacent rows, e.g., −3o. In some implementations, the offset between first nozzles in any two given rows is an integer multiple of the spacing between nozzles in a given row divided by a total number of rows. By an integer multiple, we mean approximately an integer multiple, e.g., within 5% of an integer multiple. The period of the serpentine offset (e.g., the number of rows until a zero offset is reached) can be any suitable period, e.g., three rows, four rows, or another suitable number of rows.

In the example of FIG. 3A, the offset o corresponds to the spacing between columns in the nozzle matrix 150. For example, the offset o between nozzles 131 and 132 is two columns, e.g., two pixels, and the offset o between nozzles 132 and 133 is three columns, e.g., three pixels. In some examples, the offset o is nonuniform. When the offset o nonuniform, it is possible for none of the offsets between any two (even non-adjacent) rows to be zero.

In some implementations, offset o is no more than one third of a spacing d between adjacent nozzles 102 in each row 106, e.g., the nozzle order proceeding in the cross-process direction 202 does not change row number by greater than two-thirds of the total number of rows 106, which can reduce yaw-induced print errors. In some examples, the offset between first nozzles in adjacent rows does not exceed three times the spacing of nozzles within a row divided by the total number of rows.

Referring also to FIG. 3B, which shows a zoomed out view of the nozzle matrix 201 on the print head 100, the serpentine path of the nozzles from row to row mitigates edge defects, since neither one side or another, e.g., right side or left along the cross process direction, is strongly favored by air flow (indicated by the small arrows within the nozzle matrix) along the length of the print head in the process direction. This arrangement enables a relatively even airflow, e.g., with little pressure differential between the sides of the nozzle matrix and the center of the nozzle matrix. The generally even pressure throughout the nozzle matrix prevents droplets from drawn toward the edges of the nozzle matrix, instead driving generally straight air flow along the edges of the nozzle matrix (indicated by the arrow at the edge), thus reducing the occurrence of edge defects.

A radial distance R between the centers of any pair of nozzles is a function of the spacings d and w and the offset o. In layouts in which the offset between first nozzles in adjacent rows is non-zero, the radial distance R between a center of a nozzle and a center of any other nozzle in the nozzle matrix 201 is greater than the spacing w. In layouts in which there is no offset between first nozzles in adjacent rows, then corresponding nozzles in each row are directly aligned with one another, and thus the radial distance R between these two nozzles is equal to the spacing w between the adjacent rows.

Increasing the radial distance R by disposing the rows to be offset from one another can help mitigate wood grain defects, e.g., by reducing droplet interactions. Additionally, the alternating pattern of nozzles that is achieved by incorporating an offset between rows helps to mitigate sensitivity to print head yaw, as discussed above for FIG. 2A, e.g., because inter-nozzle distances are generally similar regardless of any small radial variation in the actual print direction. In some implementations, the advantages of increasing the radial distance R by disposing the rows to be offset from one another are balanced with disadvantages of increasing a fluid supply plumbing width. For example, when the fluid supply plumbing width is sufficiently large, conductance of fluid connections between rows increases, but the supply of fluid under high demand can be limited.

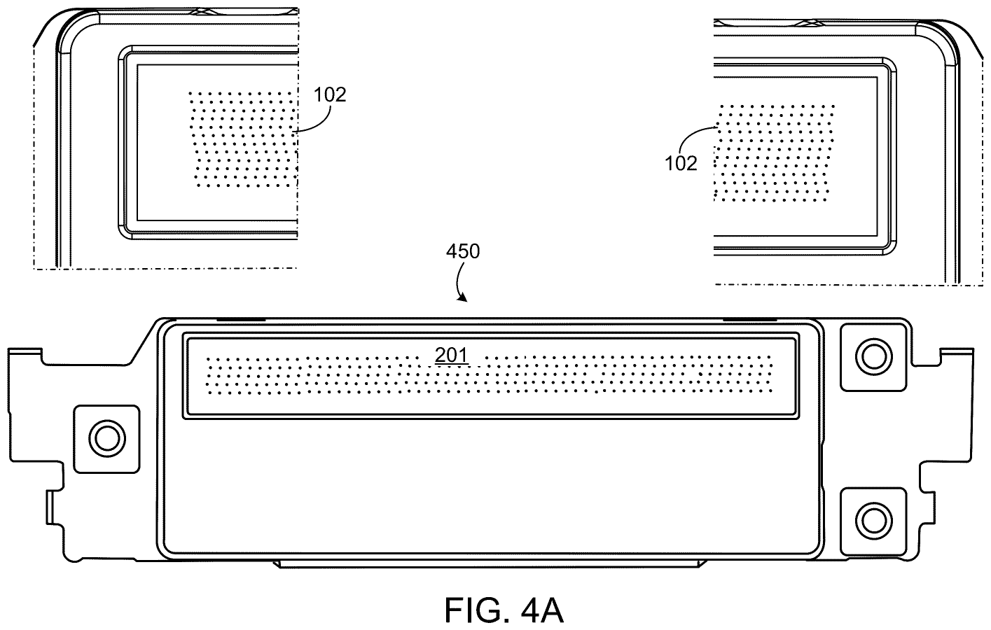

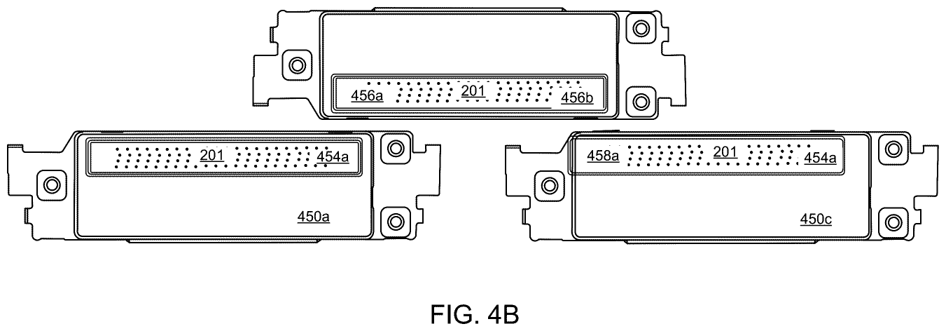

FIG. 4A shows an example print head 450 having nozzles arranged in a nozzle matrix 201 such as that described above, with rows of nozzles orthogonal to the process direction, with the spacing between nozzles within a row being greater than the spacing between adjacent rows, and with adjacent rows misaligned to generate a serpentine pattern. Zoomed in views of two edge regions of the print head 450 show detail of the nozzle matrix.

Referring to FIG. 4B, in some examples, multiple print heads 450a-c are arranged into an assembly 452, such as a print bar. The print heads 450 are arranged such that the rows of nozzles on each print head are parallel with one another and stitched together such that a small number of nozzles on one print head are translated horizontally such that the small number of nozzles on the one print head (in the process direction) are aligned with (e.g., redundant with) the same number of nozzles on an adjacent print head. In the example of FIG. 4B, six nozzles in an edge region 454a of the nozzle matrix on the print head 450a are aligned with six nozzles in an edge region 456 of the nozzle matrix on the adjacent print head 450b. Similarly, six nozzles in an edge region 458a of the nozzle matrix on the print head 450c are aligned with six nozzles in the opposite edge region 456b of the nozzle matrix on the print head 450b.

In some examples, each print head 450 of the assembly is dedicated for printing of a single color of ink different from the color of one or more of the other print heads. This arrangement allows for high resolution and high quality printing while avoiding mixing of colors that can arise when nozzles of different colors are positioned close to one another.

In some examples, a single print head can be configured for printing of multiple colors. For instance, a single print head can have a first nozzle matrix for fluid ejectors configured to print one color, and a second nozzle matrix spaced apart from the first that is for fluid ejectors configured to print a different color.

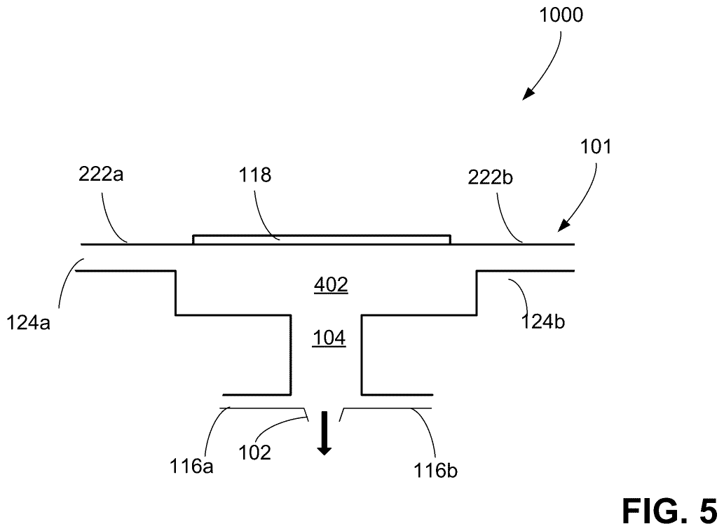

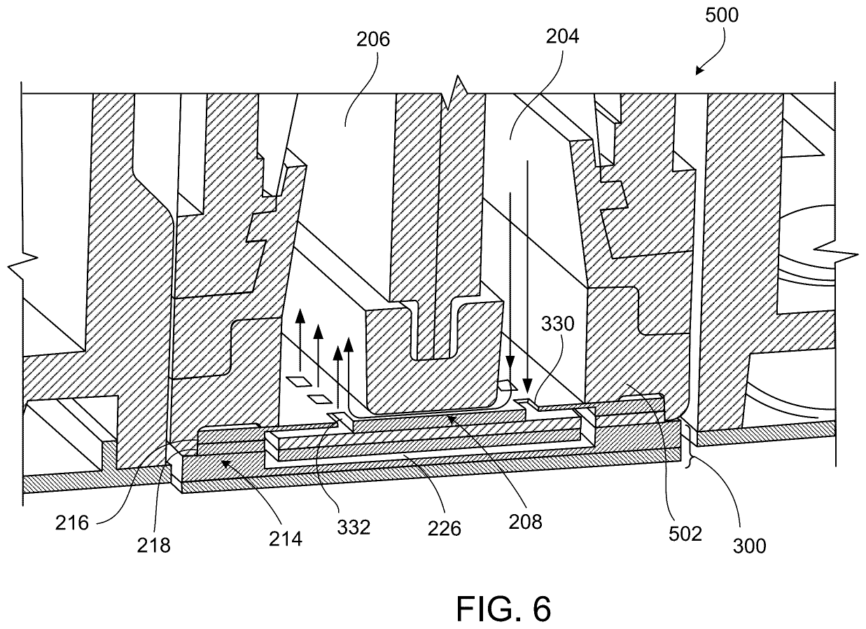

FIG. 5 depicts an example of a fluid delivery system 1000 including a fluid ejector 101, e.g., for a print head 500 shown in FIG. 6. The fluid ejector 101 includes flow pathways to transport fluid from a reservoir to a nozzle 102 of the fluid ejector. The print head 500 includes multiple such fluid ejectors 101, arranged such that the nozzles are disposed in the nozzle matrix layout described above. For instance, the fluid ejectors 101 are arranged in rows corresponding to the rows of the nozzle matrix

The fluid ejector 101 includes a descender 104 that defines a first fluid flow pathway between a pumping chamber 402 and the nozzle 102. A second fluid flow pathway 116 is defined at the nozzle end of the descender 104. The second fluid flow pathway 116, for example, is a recirculation pathway to recirculate fluid in an ejection operation, e.g., a printing operation. The recirculated fluid is, for example, returned to the reservoir and reused for a subsequent ejection operation, e.g., a subsequent printing operation. The fluid ejector 101 includes an actuator 118 operable to pump fluid through the pumping chamber 402 toward the nozzle 102.

In the example shown in FIG. 5, the descender 104 is centered relative to the pumping chamber 402. In some implementations, the descender 104 is not centered relative to the pumping chamber 402. For example, a longitudinal axis of the descender 104 can be located a distance away from the center of the pumping chamber 402.

The fluid ejector 101, for example, forms a part of the print head 500 as depicted in FIG. 6. The print head 500 ejects droplets of fluid, such as ink, biological liquids, polymers, liquids for forming electronic components, or other types of fluid, onto a surface. The print head 500 includes one or more fluid ejectors 101, each fluid ejector including a corresponding actuator 118, as described with respect to FIG. 4.

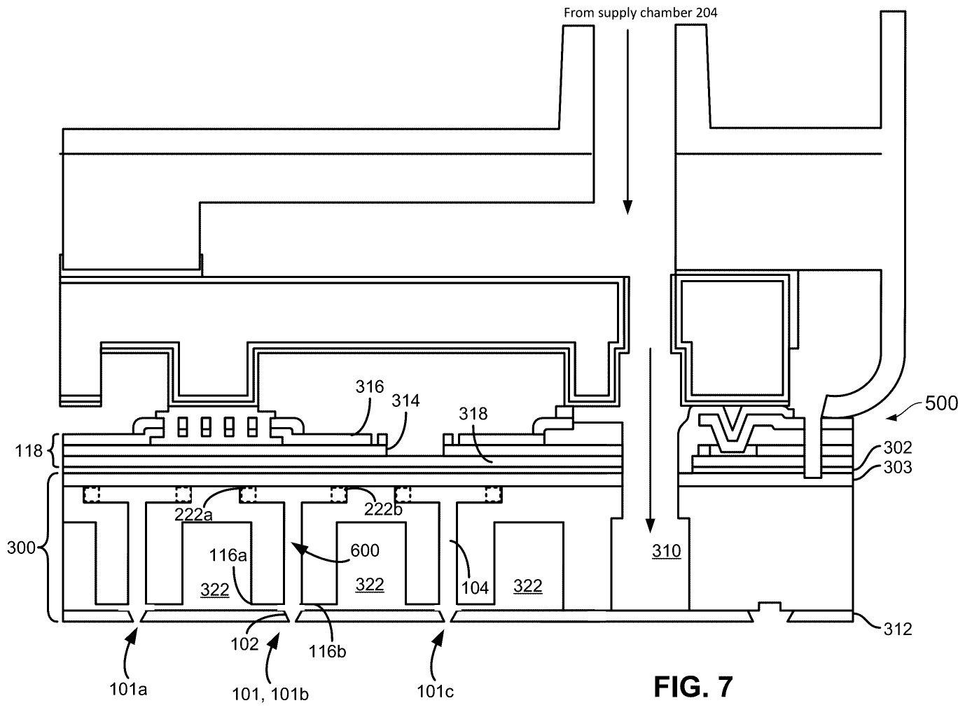

Referring to FIGS. 6 and 7, the print head 500 includes a substrate 300 coupled to a deformable membrane 303 and to an interposer assembly 214. The substrate 300 is, in some cases, a monolithic semiconductor body, such as a silicon substrate, with passages formed therethrough that define flow pathways for fluid through the substrate 300. In some implementations, the substrate 300 and the membrane 303 together define the pumping chamber 402. The substrate 300, for example, defines the fluid conduits of the fluid ejector 101, e.g., the pumping chamber 402, the descender 104, the nozzle 102, etc.

The print head 500 includes a casing 502 having an interior volume divided into a fluid supply chamber 204 and a fluid return chamber 206. In some cases, the interior volume is divided by a dividing structure 208. The bottom of the fluid supply chamber 204 and the fluid return chamber 206 is defined by the top surface of the interposer assembly 214.

The fluid supply chamber 204 includes a reservoir to contain a supply of fluid to be ejected from print head 500, e.g., to be ejected through the fluid ejectors 101. The reservoir of the fluid supply chamber 204 supplies fluid to the pumping chamber 402 of each fluid ejector. The fluid return chamber 206 includes a reservoir to contain fluid recirculated through the print head 500 through the second fluid flow pathway 116 described with respect to FIG. 4.

The interposer assembly 214 is attachable to the casing 502, such as by bonding or another mechanism of attachment. The interposer assembly 214 includes, for example, an upper interposer 216 and a lower interposer 218. The lower interposer 218 is positioned between the upper interposer 216 and the substrate 300.

A flow pathway 226 is formed to connect, e.g., fluidically connect, the fluid supply chamber 204 to the fluid return chamber 206. The upper interposer 216 includes an inlet 330 to the flow pathway 226 and an outlet 332 from the flow pathway 226. The inlet 330 and the outlet 332, for example, are formed as apertures in the upper interposer 216. The flow pathway 226 is, for example, formed in the upper interposer 216, the lower interposer 218, and the substrate 300. The flow pathway 226 enables flow of fluid from the supply chamber 204, through the substrate 300, into the inlet 330, and to the fluid ejectors 101 for ejection of fluid from the print head 500. The actuator 118 of the ejector 101, when driven, ejects fluid from the pumping chamber 402 through the nozzle 102. The flow pathway 226 also enables flow of fluid from the fluid ejector 101, into the outlet 332, and into the return chamber 206.

While FIG. 6 depicts the flow pathway 226 as a single flow pathway forming a straight passage, in some implementations, the print head 500 includes multiple flow pathways. Alternatively or additionally, one or more of the flow pathways are not straight. In the flow pathway 226, a substrate inlet 310 receives fluid from the supply chamber 204 through the inlet 330. The substrate inlet 310 extends through the substrate 300, in particular, through the membrane 303, and supplies fluid to one or more inlet feed channels 304, which supplies fluid to the fluid ejector 101 through an inlet.

As described with respect to FIG. 5, the fluid ejector 101 includes the nozzle 102. Fluid is selectively ejected from the nozzle 102 of the fluid ejector 101. The fluid is, for example, ink that is ejected onto a surface to print an image on the surface. The nozzle 102 is formed in a nozzle layer 312 of the substrate 300, e.g., on a bottom surface of the substrate 300. In some examples, the nozzle layer 312 is an integral part of the substrate 300. In some examples, the nozzle layer 312 is a layer that is deposited onto the surface of the substrate 300.

Referring specifically to FIG. 7, fluid flows through the fluid ejector 101 along an ejector flow pathway 600, e.g., an ejector flow pathway 600 of the ejector 101. The ejector flow pathway 600 further includes multiple flow pathways to transport fluid from reservoirs to eject the fluid and/or to recirculate the fluid to be ejected during a subsequent ejection operation. The ejector flow pathway 600 includes, for example, one or more ejector inlets, one or more recirculation outlets, and one or more nozzles.

In one example, to be ejected from the print head 500, a portion of fluid flows through an inlet 222 of the fluid ejector 101, through the pumping chamber 402, through the first end 406 of the descender 104, through the descender 104, through the fluid ejector 101, and out of the print head 500 through the nozzle 102. To be recirculated, a portion of fluid flows through the inlet 222, through the pumping chamber 402, through the descender 104, and through an outlet 224 of the fluid ejector 101. The inlet 222 is, for example, an inlet to the pumping chamber 402. The outlet 224 is, for example, an outlet from the descender 104.

The inlet 222 is, for example, connected to a reservoir to enable fluid flow from the reservoir, e.g., the supply chamber 204, to the ejector flow pathway 600 during an ejection operation. An inlet feed channel connects the supply chamber 204 to the inlet 222 of the fluid ejector 101. The inlet 222 includes a first end connected to the supply chamber 204 through the inlet feed channel and a second end connected to the pumping chamber 402.

The descender 104 is connected to an outlet feed channel through the second fluid flow pathway 116. The second fluid flow pathway is, for example, connected to another reservoir to facilitate a recirculation fluid flow into the other reservoir, e.g., a reservoir of the return chamber 206, from the ejector flow pathway 600 during the ejection operation. The outlet feed channel connects the second fluid flow pathway 116 to the return chamber 206.

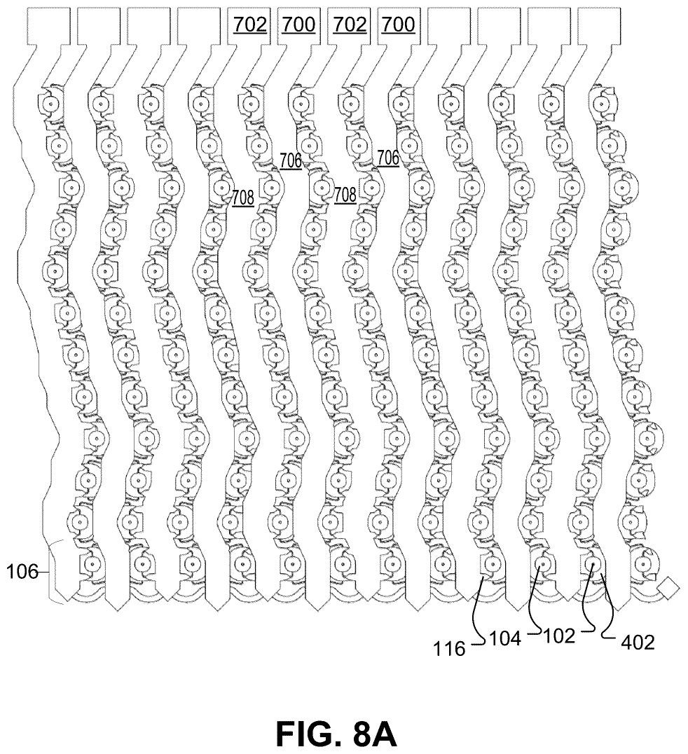

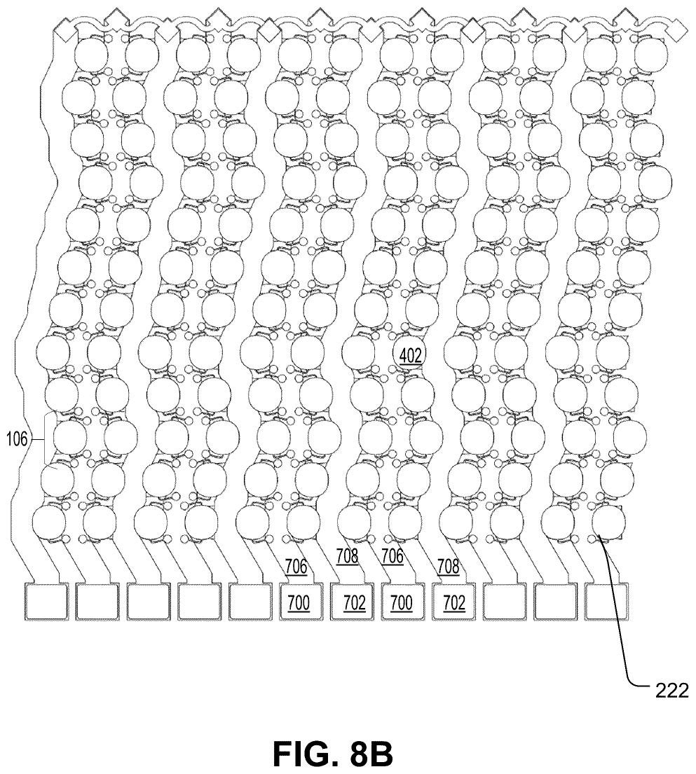

FIGS. 8A and 8B illustrate bottom and top views, respectively, of an example nozzle matrix layout such as that described above, along with inlet and outlet feed channels 700, 702. The nozzles 102 are arranged in rows 106, as discussed with respect to FIGS. 3A-3B, with the fluid ejectors (e.g., including descenders (not shown) and pumping chambers 402) arranged in an array corresponding the nozzle matrix. The inlet and outlet feed channels 700, 702 are located on a common side of the nozzle matrix and are connected to fluid ejectors corresponding to the nozzles in the nozzle matrix. Inlet fluid connections 706 between each inlet feed channel 700 to the fluid ejectors supplied by that inlet feed channel 700, and outlet fluid connections 708 between each outlet feed channel 702 and the fluid ejectors that supply that outlet feed channel 702, extend between the rows of fluid ejectors.

The arrangement of inlet and outlet feed channels 700, 702 on a common side of the nozzle matrix facilitates compact arrangement of the fluid pathways, e.g., saving space on the print head die.

Referring again to FIG. 7, in some implementations, the actuator 118 is a piezoelectric actuator including first and second electrodes. The piezoelectric layer 314 is positioned between the first and second electrodes. The first electrode is, for example, a drive electrode 316, and the second electrode is, for example, a ground electrode 318. The drive electrode 316 and the ground electrode 318 are, for example, formed from a conductive material (e.g., a metal), such as copper, gold, tungsten, indium-tin-oxide (ITO), titanium, platinum, or a combination of conductive materials. The thickness of the drive electrode 316 and the ground electrode 318 is, e.g., about 2 μm or less, e.g., about 1 μm, about 0.5 μm, about 0.2 μm, etc.

The membrane 303 is positioned between the actuator 118 and the pumping chamber 402, thereby isolating the ground electrode 318 from fluid in the pumping chamber 402. In some examples, the membrane 303 is a layer separate from the substrate 300. In some examples, the membrane 303 is unitary with the substrate 300. While FIG. 7 depicts the ground electrode 318 positioned between the membrane 303 and the piezoelectric layer 314, in some implementations, the drive electrode 316 is positioned between the membrane 303 and the piezoelectric layer 314.

To actuate the piezoelectric actuator 118, an electrical voltage can be applied between the drive electrode 316 and the ground electrode 318 to apply a voltage to the piezoelectric layer 314. The applied voltage induces a polarity on the piezoelectric actuator that causes the piezoelectric layer 314 to deflect, which in turn deforms the membrane 303. The deflection of the membrane 303 causes a change in volume of the pumping chamber 402, producing a pressure pulse in the pumping chamber 402. In the configurations of the fluid ejector 101 described herein, for a given value for the change in volume of the pumping chamber 402 when the piezoelectric actuator 118 is actuated, the resonance frequency can be higher, thereby enabling the actuator 118 to be more rapidly actuated to eject fluid. In particular, a firing frequency of the actuator 118 can be higher.

The print head 500, in some implementations, includes a controller to apply a voltage to the drive electrode 316 to deform the membrane 303. The controller, for example, operates a drive, e.g., a controllable voltage source to modulate a voltage applied to the drive electrode 316. The applied voltage causes the membrane 303 to deform by a selectable amount. In some implementations, the voltage is applied to the drive electrode 316 in a manner such that the membrane 303 deforms away from the pumping chamber 402. The voltage applied, for example, results in a voltage differential, e.g., a polarity, between the ground electrode 318 and the drive electrode 316 that deflects the piezoelectric layer 314 toward the drive electrode 316. In this regard, if the ground electrode 318 is positioned between the membrane 303 and the piezoelectric layer 314, the membrane 303 deforms away from the pumping chamber 402.

In some implementations, the membrane 303 is formed of a single layer of silicon, e.g., single crystalline silicon. In some implementations, the membrane 303 is formed of another semiconductor material, one or more layers of oxide, such as aluminum oxide (AlO2) or zirconium oxide (ZrO2), glass, aluminum nitride, silicon carbide, other ceramics or metals, silicon-on-insulator, or other materials. The membrane 303 is, for example, formed of an inert material having a compliance such that the membrane 303 flexes sufficiently to eject a drop of fluid when the actuator 118 is driven. In some examples, the membrane 303 is secured to the actuator 118 with an adhesive portion 302. In some examples, two or more of the substrate 300, the nozzle layer 312, and the membrane 303 are formed as a unitary body.

The actuators described herein are, in some implementations, unimorphs. In this regard, an actuator in such implementations includes a single active layer and a single inactive layer. The actuator 118, for example, includes the membrane 303. In this regard, the piezoelectric layer 314 corresponds to the active layer, and the membrane 303, e.g., the membrane 303, corresponds to the inactive layer.

While the fluid ejector 101 has been described as including both the actuator 118 and the membrane 303, in some examples, the fluid ejector 101 does not include a membrane 303. The ground electrode 318 is, for example, formed on the back side of the piezoelectric layer 314 such that the piezoelectric layer 314 is directly exposed to fluid in the pumping chamber 402.

A number of implementations have been described. Nevertheless, various modifications are present in other implementations.

What is claimed is:

1. An ink jet printing system comprising:
a print head comprising multiple fluid ejectors, each fluid ejector comprising a corresponding nozzle defined in a bottom surface of the print head, each nozzle configured to eject a liquid onto a substrate,
wherein the nozzles are arranged in an array comprising four or more parallel rows, the rows extending along a direction that is perpendicular to a process direction of the ink jet printing system, wherein the process direction is the direction of relative motion between the print head and the substrate during operation of the print head,
wherein a spacing between adjacent nozzles in each row is such that a nozzle density in each row is less than 75 nozzles per inch, and
wherein a spacing between adjacent rows in the process direction is less than the spacing between adjacent nozzles in each row.

2. The ink jet printing system of claim 1, wherein the spacing between adjacent nozzles in each row is such that the nozzle density in each row is 50 nozzles per inch.

3. The ink jet printing system of claim 1, wherein the nozzles are arranged in at least eight rows.

4. The ink jet printing system of claim 1, wherein the nozzles are arranged in at least twelve rows.

5. The ink jet printing system of claim 1, wherein the spacing between adjacent rows in the process direction is less than 500 μm.

6. The ink jet printing system of claim 1, wherein the spacing between adjacent nozzles in each row is such that the nozzle density in each row is 50 nozzles per inch, wherein the spacing between adjacent rows is between 400 μm and 450 μm, and wherein the nozzles are arranged in exactly twelve rows.

7. The ink jet printing system of claim 1, wherein a first nozzle in a given row is offset along the direction of the row relative to a first nozzle in an adjacent row.

8. The ink jet printing system of claim 1, wherein a first nozzle of each of the rows defines a serpentine path extending along the process direction.

9. The ink jet printing system of claim 1, comprising multiple feed channels defined in the print head, each feed channel fluidically connected to a corresponding subset of the fluid ejectors.

10. The ink jet printing system of claim 9, wherein the fluid ejectors are arranged in an array corresponding to the array of nozzles, and wherein all of the multiple feed channels are disposed on a common side of the array of fluid ejectors.

11. The ink jet printing system of claim 10, wherein fluid connections between each feed channel and the corresponding subset of the fluid ejectors extend between rows of fluid ejectors in the array of fluid ejectors.

12. The ink jet printing system of claim 11, comprising a print bar comprising multiple print heads, wherein the rows of nozzles on each print head are aligned with the rows of nozzles on each other print head.

13. The ink jet printing system of claim 1, wherein the print heads are rectangular print heads.

14. The ink jet printing system of claim 1, wherein each fluid ejector comprises:
a pumping chamber fluidically connected to the nozzle of the fluid ejector by a descender; and
an actuator configured to apply an actuation force to fluid in the pumping chamber to cause ejection of fluid from the nozzle of the fluid ejector.

15. The ink jet printing system of claim 14, wherein each actuator comprises:
a piezoelectric element; and
a membrane defining a wall of the pumping chamber opposite the descender, the membrane disposed between the pumping chamber and the piezoelectric element.

16. The ink jet printing system of claim 14, wherein the descender is centered relative to the pumping chamber.

17. The ink jet printing system of claim 14, wherein each fluid ejector comprises a recirculation channel fluidically connected to the descender such that, during operation, fluid not ejected from the nozzle of the fluid ejector flows from the nozzle through the recirculation channel and to a reservoir.

18. The ink jet printing system of claim 1, wherein the spacing between adjacent nozzles in each row is uniform for centrally located adjacent nozzles and non-uniform for adjacent nozzles located at edges of each row.

19. The ink jet printing system of claim 1, wherein the spacing between adjacent rows is uniform throughout the array.

20. The ink jet printing system of claim 1, wherein an offset between first nozzles in any two given rows is an integer multiple of the spacing between nozzles in a given row divided by a total number of rows.

21. The ink jet printing system of claim 20, wherein the offset between first nozzles in adjacent rows does not exceed three times a spacing of nozzles within a row divided by the total number of rows.

22. The ink jet printing system of claim 1,
wherein the array of nozzles comprises columns of nozzles, the columns extending along a direction that is parallel to the process direction of the ink jet printing system, and
wherein nozzles in adjacent rows are separated by at least one intervening column.

23. The ink jet printing system of claim 22, wherein nozzles in adjacent rows are separated by four or fewer intervening columns.

24. The ink jet printing system of claim 1, wherein the array comprises more than four parallel rows.

25. A method of inkjet printing using the system of claim 1, the method comprising:
ejecting ink from the nozzles in the array, wherein the array comprises columns of nozzles, the columns extending along a direction that is parallel to the process direction of the ink jet printing system, the ejecting comprising:
ejecting ink from a first nozzle in the array, the first nozzle disposed in a first column of the array; and
after ejecting ink from the first nozzle, ejecting ink from a second nozzle in the array, the second nozzle disposed in second column of the array that is not adjacent to the first column of the first nozzle.

26. The method of claim 25, wherein the first and second columns are separated by between one and four other columns.

27. The method of claim 25, wherein the ejecting comprises ejecting ink sequentially from multiple nozzles in the array, in which sequentially operated nozzles are disposed in non-adjacent columns in the array.

28. The method of claim 27, wherein nozzles disposed in adjacent columns are separated by a number of rows that is no more than two-thirds of the total number of rows in the array.

29. The method of claim 25, wherein the array comprises multiple sub-groups of nozzles, the sub-groups having a common arrangement of nozzles, and wherein the ejecting comprises:
ejecting ink from a first nozzle of each sub-group of nozzles, each first nozzle disposed in a first column of the respective sub-group; and
after ejecting ink from the first nozzle of each sub-group, ejecting ink from a second nozzle of each sub-group, each second nozzle disposed in second column of the respective sub-group that is not adjacent to the first column of the first nozzle of the sub-group.

30. The method of claim 29, wherein each sub-group of nozzles is supplied by a corresponding feed channel, and wherein consecutive nozzles of a given sub-group along the corresponding feed channel are separated by a number of rows that is no more than two-thirds of the total number of rows in the sub-group of nozzles.
